(19) United States
(12) Patent Application Publication
(10) Pub. No.: US 2020/0072233 A1
(43) Pub. Date: Mar. 5, 2020

(54) Centrifugal Fan Blade Assembly and Centrifugal Fan

(71) Applicant: GREE ELECTRIC APPLIANCES, INC. OF ZHUHAI, Zhuhai City, Guangdong (CN)

(72) Inventors: Yasong TIAN, Zhuhai, Guangdong (CN); Jianjian LI, Zhuhai, Guangdong (CN); Jun XIONG, Zhuhai, Guangdong (CN); Junhong WU, Zhuhai, Guangdong (CN); Dawei LI, Zhuhai, Guangdong (CN)

(21) Appl. No.: 16/468,470

(22) PCT Filed: Oct. 13, 2017
(86) PCT No.: PCT/CN2017/106028

§ 371 Date: Jun. 11, 2019

(30) Foreign Application Priority Data
Dec. 16, 2016 (CN) 201611169462.1

(51) Int. Cl. F04D 29/28; F04D 29/30; F04D 29/66

(52) U.S. Cl. CPC F04D 29/282; F05D 2240/303; F04D 29/663; F04D 29/30

(57) ABSTRACT

Disclosed are a centrifugal fan blade assembly and a centrifugal fan, comprising a plurality of blades, a blade leading edge of at least some of the blades being provided with an interference groove, the interference groove extending in a width direction of the blade. By providing the interference groove extending in the width direction of the blade on the blade leading edge, when the fan blade assembly is running, the interference groove changes noise frequency, thereby preventing the blade leading edge from producing a relatively large broadband noise after being impacted by a high speed air flow, thus effectively reducing noise.

### TECHNICAL FIELD

The disclosure relates to the field of a centrifugal fan, and particularly, to a centrifugal fan blade assembly and a centrifugal fan.

### BACKGROUND

When the device having a centrifugal fan blade assembly runs, air flows impact one another, and air flows impact objects as well, which will result in aerodynamic noise, thus affect people's daily work and study.

The aerodynamic simulation and calculation are performed for the fan blade assembly, and it is found that the maximum value of its broadband noise is generated at the leading edge of the blade. The structure of the leading edge is thin and sharp, and it is easy to generate large broadband noise after being impacted by a high-speed air flow.

### SUMMARY OF THE INVENTION

The objective of the present invention is to provide a centrifugal fan blade assembly and a centrifugal fan, which are capable of reducing noise.

The present invention provides a centrifugal fan blade assembly including a plurality of blades, wherein a leading edge of at least some of the blades is provided with an interference groove extending in a width direction of the blade.

Further, the interference groove is a V-shaped groove.

Further, an apex angle of the V-shaped groove is α, wherein 30°≤α≤85°.

Further, a groove depth of the V-shaped groove is h, wherein 0 mm<h≤3 mm.

Further, each of the blades is provided with a plurality of interference grooves.

Further, a distance between two adjacent interference grooves is d, wherein, 0 mm<d≤1 mm.

Further, three interference grooves are provided, and the three interference grooves are evenly distributed on the leading edge of the blade.

The present invention further provides a centrifugal fan, comprising the centrifugal fan blade assembly above.

According to the centrifugal fan blade assembly and the centrifugal fan of the present invention, the leading edge of the blade is provided with the interference groove extending in the width direction of the blade. When the blade operates, the interference groove changes the noise frequency and prevents the leading edge of the blade from generating large broadband noise after being impacted by the high-speed air flow, thereby effectively reducing noise.

### BRIEF DESCRIPTION OF THE DRAWINGS

The accompanying drawings constituting a part of the present application are provided for a further understanding of the present invention. The illustrative embodiments of the present invention and the description are used to explain the present invention, but not intended to limit the present invention. In the drawings:

FIG. 1 is a perspective structural schematic view of a centrifugal blade assembly according to the present invention;

FIG. 2 is a perspective structural schematic view of a blade according to the present invention;

FIG. 3 is a structural schematic front view of the centrifugal fan blade assembly according to the present invention;

FIG. 4 is a partial enlarged view of the location marked with A shown in FIG. 3;

FIG. 5 is a schematic view with dimension indications of the partial enlarged view shown in FIG. 4.

Wherein, the above figures include the following reference numerals:

10. blade; 11. leading edge of blade; 11a. interference groove;

20. wheel boss; 21. through opening.

### DETAILED DESCRIPTION OF THE PREFERRED EMBODIMENTS

The present disclosure will be described in more details with reference to the accompanying figures and embodiments.

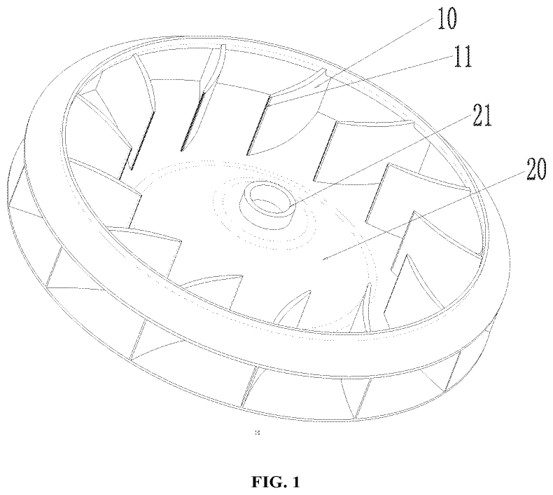

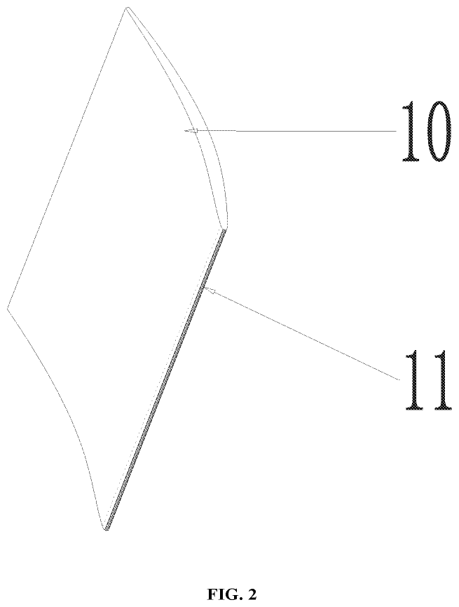

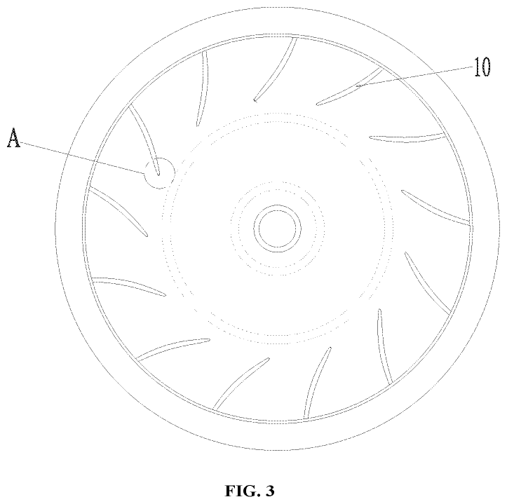

As shown in FIGS. 1 to 5, the centrifugal fan blade assembly of the present disclosure includes a plurality of blades 10, and the leading edge 11 of at least some of the blades 10 is provided with an interference groove 11a extending in the width direction of the blade 10. In the specific configuring process, all of the blades 10 may be provided with interference grooves 11a; or only some of the blades 10 are provided with interference grooves, for example in an alternate manner; or different blades 10 are provided with different numbers or types of interference grooves 11a, which are arranged in accordance with a particular regularity. According to the present disclosure, the leading edge 11 of the blade is provided with the interference groove 11a extending in the width direction of the blade 10, and the interference grooves 11a form a groove structure which is arranged according to a certain shape or regularity. When the blade operates, the air flow is disturbed at the interference groove 11a, which changes the noise frequency and prevents the leading edge 11 of the blade from generating large broadband noise after being impacted by the high-speed air flow, thereby effectively reducing noise.

Preferably, the interference groove 11a is a V-shaped groove, which can more effectively prevent the generation of broadband noise, thereby reducing the noise decibel more effectively. Preferably, the apex angle O of the V-shaped groove is α, and when the value of α has a range of 30°≤α≤85°, the effect of reducing noise is more significant. In addition, the groove depth of the V-shaped groove is h, and when the value of h has a range of 0 mm<h≤3 mm, not only the effect of reducing noise can be ensured, but also the machining is convenient.

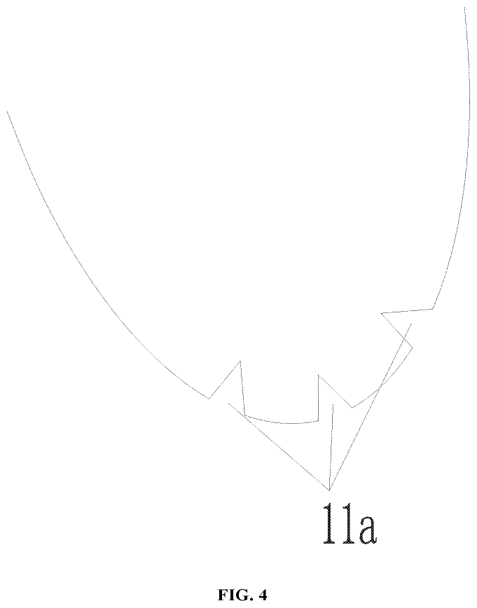

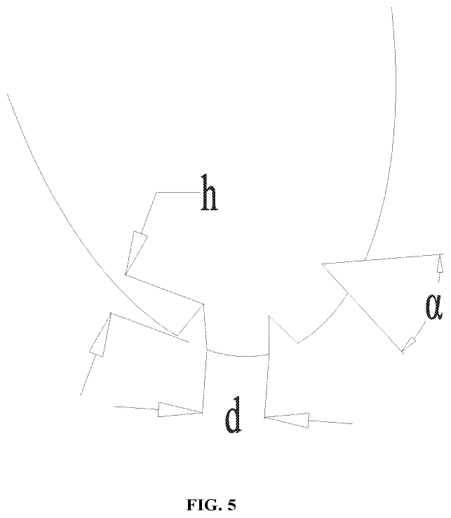

As shown in FIG. 4 and FIG. 5, each blade is provided with a plurality of interference grooves 11a, and the plurality of interference grooves 11a are arranged to form a zigzag structure, which is more favorable for reducing noise. Preferably, the distance between two adjacent interference grooves 11a is d, wherein, when 0 mm<d≤1 mm, the effect of reducing noise is better. In the specific embodiment shown in FIG. 4, three interference grooves 11a are provided, and the three interference grooves 11a are evenly distributed on the leading edge 11 of the blade.

In an embodiment of the present invention, a through opening 21 is disposed in the center of the rear disc, which is namely a wheel center structure. As shown in FIG. 1, the wheel boss 20 protrudes upwardly, so that sufficient space is ensured for installing a motor.

According to the aerodynamic simulation and calculation for the centrifugal fan blade assembly, the maximum broadband noise of the blade of a conventional centrifugal fan is mostly distributed at the thin and sharp leading edge. At a certain speed, the maximum value of the broadband noise reaches 65.0 dB. With the design of the above embodiment, at the same speed, the maximum value of the broadband noise is 61.2 dB, which is 3.8 dB lower than that of the blade of the conventional centrifugal fan.

The present disclosure also provides a centrifugal fan, including the foregoing centrifugal fan blade assembly, thereby effectively reducing noise.

From the above description, it can be seen that the foregoing embodiments of the present invention achieve the following technical effects:

According to the centrifugal fan blade assembly and the centrifugal fan of the present disclosure, the leading edge 11 of the blade is provided with the interference groove 11a extending in the width direction of the blade 10. When the blade operates, the interference groove 11a changes the noise frequency and prevents the leading edge 11 of the blade from generating large broadband noise after being impacted by the high-speed air flow, thereby effectively reducing noise.

What described above are preferred embodiments of the present invention, but not intended to limit the present invention. For those skilled in the art, various amendments and modifications can be made. Any modifications, equivalent substitutions and improvements made within the spirits and principles of the present invention are all within the protection scope of the present invention.

What is claimed is:

1. A centrifugal fan blade assembly, comprising a plurality of blades, wherein, a leading edge of at least some of the blades is provided with an interference groove extending in a width direction of the blade.

2. The centrifugal fan blade assembly according to claim 1, wherein, the interference groove is a V-shaped groove.

3. The centrifugal fan blade assembly according to claim 2, wherein, an apex angle of the V-shaped groove is α, wherein 30°≤α≤85°.

4. The centrifugal fan blade assembly according to claim 2, wherein, a groove depth of the V-shaped groove is h, wherein 0 mm<h≤3 mm.

5. The centrifugal fan blade assembly according to claim 1, wherein, each of the blades is provided with a plurality of interference grooves.

6. The centrifugal fan blade assembly according to claim 5, wherein, a distance between two adjacent interference grooves is d, wherein, 0 mm<d≤1 mm.

7. The centrifugal fan blade assembly according to claim 5, wherein, three interference grooves are provided, and the three interference grooves are evenly distributed on the leading edge of the blade.

8. A centrifugal fan, comprising the centrifugal fan blade assembly defined in claim 1.

9. The centrifugal fan according to claim 8, wherein, the interference groove is a V-shaped groove.

10. The centrifugal fan according to claim 9, wherein, an apex angle of the V-shaped groove is α, wherein 30°≤α≤85°.

11. The centrifugal fan according to claim 9, wherein, a groove depth of the V-shaped groove is h, wherein 0 mm<h≤3 mm.

12. The centrifugal fan according to claim 8, wherein, each of the blades is provided with a plurality of interference grooves.

13. The centrifugal fan according to claim 12, wherein, a distance between two adjacent interference grooves is d, wherein, 0 mm<d≤1 mm.

14. The centrifugal fan according to claim 12, wherein, three interference grooves are provided, and the three interference grooves are evenly distributed on the leading edge of the blade.
